(19) United States
(12) Patent Application Publication
(10) Pub. No.: US 2012/0184760 A1
(43) Pub. Date: Jul. 19, 2012

(54) REMOVAL OF MONOGLYCERIDES FROM FATTY ACID CONCENTRATES

(75) Inventor: Asgeir Saebo, Eidsnes (NO)

(73) Assignee: PHARMA MARINE AS, Sovik (NO)

(21) Appl. No.: 13/349,121

(22) Filed: Jan. 12, 2012

Related U.S. Application Data
(60) Provisional application No. 61/432,881, filed on Jan. 14, 2011.

(51) Int. Cl. C11C 3/00; C12S 3/00

(52) U.S. Cl. 554/224; 435/267

(57) ABSTRACT

Unsaturated fatty acids, in particular highly unsaturated acids like eicosapentaenoic acid (EPA) and docosahexaenoic acid (DHA) are typically provided in the form of ethyl esters. A major challenge in the concentration of EPA and particularly DHA by molecular distillation, is the accumulation of monoglycerides in the product. The present invention offers a solution to completely remove the monoglycerides from the ethyl ester products.

### CROSS REFERENCE TO RELATED APPLICATION

This application claims the benefit of pending U.S. Provisional Application No. 61/432,881 filed Jan. 14, 2011, the entire contents of which are incorporated herein by reference.

### FIELD OF THE INVENTION

The present invention relates to the production of fatty acid concentrates, and in particular to fatty acid concentrates with low levels of monoglycerides.

### BACKGROUND OF THE INVENTION

Omega-3 fatty acids are often referred to as “essential” fatty acids (EFAs) because they are needed for human health but are not sufficiently produced by the body alone. The two major health promoting omega-3 polyunsaturated fatty acids are eicosapentaenoic acid (EPA) and docosaliexaenoic acid (DHA). EPA and DHA are naturally found in certain cold-water fatty fish such as salmon, tuna, and mackerel. They can also be derived in the body from alpha-linolenic acid (ALA), which is an omega-3 fatty acid found in certain seeds and plant-based oils. However, the body is very inefficient at converting ALA into EPA and DHA.

The modern diet is typically deficient in omega-3 essential fatty acids and has become overloaded with pro-inflammatory omega-6 fatty acids, especially arachidonic acid. This heavy imbalance of omega-6 to omega-3 fatty acids in the modern diet is thought to lead to an overall inflammatory state that contributes to certain diseases. The increased consumption of vegetable oils and shortenings, beef, and dairy is one of the major reasons for the high amount of omega-6 fatty acids in the diet and the imbalance between omega-6 to omega-3 fatty acids. The North American population, in particular, has among the lowest dietary intake of omega-3 fatty acids found in the world and the highest amount of the pro-inflammatory omega-6 fatty acids.

Recent scientific developments have shown that the omega-3 fatty acids, in particular EPA and DHA, play a vital role in central nervous system, cognitive, cardiovascular, joint, immune and metabolic function. EPA and DHA not only protect good overall physical and emotional health, but also can reduce the risk of cardiac disease and exert powerful anti-inflammatory effects that can help treat certain diseases. The benefits of EPA and DHA have been studied across a wide range of illnesses, including, but not limited to heart disease, high cholesterol, hypertension, arthritis, back pain, osteoporosis, psoriasis, lupus, Crohn's Disease, back pain, dry eyes, depression, bipolar disorder, ADHD, and stress-related disorders. Omega-3 fatty acids have also been shown to be important in pregnant women and infants, where their depletion may lead to visual or central nervous system problems.

When concentrates of eicosapentaenoic acid (EPA) and docosahexaenoic acid (DHA) are made, the triacylglyceride source material (fish oil typically) is converted to fatty acid ethyl esters (FAEE) by addition of ethanol and a proper catalyst. In this process, the conversion from tria-acyl glycerol (TAG) to FAEE is not complete, and the reaction mixture will contain small amounts of mono-acyl glycerol (MAG) and traces of di-acylglycerols (DAG). When distilling the product in a molecular distillation plant (short path distillation) to obtain concentrates of EPA and DHA, the ethyl esters of EPA and DHA are easily separated by from DAG, but the amount of MAG may amount to 10%.

What is needed in the art is improved methods for producing fatty acid concentrates with low levels of monoglycerides.

### SUMMARY OF THE INVENTION

The present invention relates to the production of fatty acid concentrates, and in particular to fatty acid concentrates with low levels of monoglycerides.

Accordingly, in some embodiments, the present invention provides processes for obtaining a fatty acid ethyl ester concentrate of polyunsaturated fatty acids comprising less than approximately 5% of monoglycerides comprising a) adding a catalyst to an ethyl ester composition comprising an undesirable monoglyceride content under conditions such that ethyl esters react with said monoglycerides to produce di- and triglycerides and b) collecting ethyl ester substantially free of monoglycerides by a subsequent distillation step. In some embodiments, the catalyst is a lipase. In some embodiments, the lipase is immobilized.

In some embodiments, the present invention provides an ethyl ester concentrate of DHA produced by a molecular distillation process comprising above 40% DHA and less than 1% monoglycerides.

In some embodiments, the present invention provides processes for removing glycerides from a DHA concentrate product or intermediate comprising a) adding a catalyst and applying vacuum to esterify free fatty acids to the glycerides present and 2) subsequently distilling the reaction mixture. In some embodiments, the catalyst is a lipase. In some embodiments, the lipase is immobilized. In some embodiments, the lipase is selected from the group consisting of Thermomyces Lanuginosus lipase, Rhizomucor miehei lipase, Candida Arctica lipase, Pseudomonas fluorescense lipase and Mucor javanicus lipase.

In some embodiments, the present invention provides an ethyl ester concentrate, finished product or an intermediate, of DHA, produced by a molecular distillation process comprising above 40% DHA in ethyl ester form and less than 1% monoglycerides.

In some embodiments, the present invention provides a free fatty acid concentrate of DHA, product or intermediate, produced by a molecular distillation process, comprising above 40% DHA and less than 1% monoglycerides.

In some embodiments, the present invention provides processes to remove monoglycerides from a fatty acid ethyl ester concentrate of polyunsaturated fatty acids comprising a) treating an ethyl ester composition comprising fatty acid ethyl esters and an undesirable amount of monoglycerides under conditions with a catalyst such that said fatty acid ethyl esters react with said monoglycerides to produce di- and triglycerides; and b) distilling said composition to collect an ethyl ester concentrate comprising less than about 3% w/w monoglycerides. In some embodiments, the undesirable amount of monoglycerides is more than 5% monoglycerides w/w or the composition. In some embodiments, the processes further comprise the step of applying a vacuum during said treating so that free fatty acids are esterified to said glycerides. In some embodiments, the ethyl ester composition is prepared from a marine oil. In some embodiments, the ethyl ester composition is an ethyl ester concentrate, preferably prepared from a marine oil, of docosahexaenoic acid (DHA) and/or eicosapentaenoic acid (EPA). In some embodiments, the concentrate comprises greater than about 35%, 40%, 50%, or 60% EPA or DHA up to about 80%, 90%, or 95% DHA, EPA or DHA and EPA combined on a weight/weight (w/w) basis. In some embodiments, the marine oil is a fish oil or squid oil. In some embodiments, the catalyst is a lipase. In some embodiments, the lipase is immobilized. In some embodiments, the lipase is selected from the group consisting of Thermomyces Lanuginosus lipase, Rhizomucor miehei lipase, Candida Arctica lipase, Pseudomonas fluorescense lipase and Mucor javanicus lipase.

In some embodiments, the process further comprises distilling the enzymatically-treated composition to collect an ethyl ester concentrate comprising less than about 2% w/w monoglycerides. In some embodiments, the processes further comprise distilling the enzymatically-treated composition to collect an ethyl ester concentrate comprising less than about 1% w/w monoglycerides. In some embodiments, the processes further comprise distilling the enzymatically-treated composition to collect an ethyl ester concentrate comprising less than about 0.5% w/w monoglycerides. In some embodiments, the compositions further comprise distilling the enzymatically-treated composition to collect an ethyl ester concentrate that is substantially free of monoglycerides. In some embodiments, the ethyl ester concentrate produced by said distilling comprises less than about 0.5% w/w of a combination of diglycerides and triglycerides. In some embodiments, the ethyl ester concentrate produced by said distilling comprises less than about 0.1% w/w of a combination of diglycerides and triglycerides. In some embodiments, the ethyl ester concentrate produced by said distilling comprises greater than about 35% DHA. In some embodiments, the ethyl ester concentrate produced by said distilling comprises greater than about 40% DHA. In some embodiments, the ethyl ester concentrate produced by said distilling comprises from about 40% to about 60% DHA. In some embodiments, the ethyl ester concentrate remains substantially clear when stored at 0° C. for 3 hours in the absence of a cold filtration process. In some embodiments, the ethyl ester concentrate contains substantially no solid precipitates when stored at 4° C. for more than 1, 5, 10, 20, 50 or 100 days. In some embodiments, the ethyl ester concentrate contains no solid precipitates when stored at 4° C. for more than 1, 5, 10, 20, 50 or 100 days.

In some embodiments, the present invention provides an ethyl ester concentrate of DHA produced by the processes described above. In some embodiments, the ethyl ester concentrate characterized in containing more than 40% DHA w/w and less than 1% monoglycerides w/w, preferably less than 0.5% or 0.3% monoglycerides w/w.

In some embodiments, the present invention provides processes to remove an undesirable amount of glycerides from a DHA concentrate product or intermediate comprising free fatty acids and glycerides, said process comprising a) adding a catalyst to said DHA concentrate to form a reaction mixture and applying a vacuum to esterify said free fatty acids to said glycerides; and b) distilling said reaction mixture. In some embodiments, the catalyst is a lipase. In some embodiments, the lipase is immobilized. In some embodiments, lipase is selected from the group consisting of Thermomyces Lanuginosus lipase, Rhizomucor miehei lipase, Candida Arctica lipase, Pseudomonas fluorescense lipase and Mucor javanicus lipase. In some embodiments, the undesirable amount of glycerides is more than 5% monoglycerides w/w or the composition. In some embodiments, the fatty acid composition is prepared from a marine oil. In some embodiments, the fatty acid composition is a fatty acid concentrate, preferably prepared from a marine oil or ethyl ester concentrate of marine oil, of docosahexaenoic acid (DHA) and/or eicosapentaenoic acid (EPA). In some embodiments, the concentrate comprises greater than about 35%, 40%, 50%, or 60% EPA or DHA up to about 80%, 90%, or 95% DHA, EPA or DHA and EPA combined on a weight/weight (w/w) basis. In some embodiments, the marine oil is a fish oil or squid oil.

In some embodiments, the process further comprises distilling the enzymatically-treated composition to collect a concentrate comprising less than about 2% w/w monoglycerides. In some embodiments, the processes further comprise distilling the enzymatically-treated composition to collect a concentrate comprising less than about 1% w/w monoglycerides. In some embodiments, the processes further comprise distilling the enzymatically-treated composition to collect a concentrate comprising less than about 0.5% w/w monoglycerides. In some embodiments, the compositions further comprise distilling the enzymatically-treated composition to collect a concentrate that is substantially free of monoglycerides. In some embodiments, the fatty acid concentrate produced by said distilling comprises less than about 0.5% w/w of a combination of diglycerides and triglycerides. In some embodiments, the fatty acid concentrate produced by said distilling comprises less than about 0.1% w/w of a combination of diglycerides and triglycerides. In some embodiments, the fatty acid concentrate produced by said distilling comprises greater than about 35% DHA. In some embodiments, the fatty acid concentrate produced by said distilling comprises greater than about 40% DHA. In some embodiments, the fatty acid concentrate produced by said distilling comprises from about 40% to about 60% DHA. In some embodiments, the fatty acid concentrate remains substantially clear when stored at 0° C. for 3 hours in the absence of a cold filtration process. In some embodiments, the fatty acid concentrate contains substantially no solid precipitates when stored at 4° C. for more than 1, 5, 10, 20, 50 or 100 days. In some embodiments, the fatty acid concentrate contains no solid precipitates when stored at 4° C. for more than 1, 5, 10, 20, 50 or 100 days.

In some embodiments, the present invention provides a fatty acid concentrate of DHA produced by the processes described above. In some embodiments, the fatty acid concentrate characterized in containing more than 40% DHA w/w and less than 1% monoglycerides w/w, preferably less than 0.5% or 0.3% monoglycerides w/w.

In some embodiments, the present invention provides an ethyl ester concentrate, finished product or intermediate, of DHA, comprising greater than 35% DHA in ethyl ester form and less than 3% monoglycerides. In some embodiments, the ethyl ester concentrate, finished product or intermediate comprises less than about 2% w/w monoglycerides. In some embodiments, the ethyl ester concentrate, finished product or intermediate comprises less than about 1% w/w monoglycerides. In some embodiments, the ethyl ester concentrate, finished product or intermediate comprises less than about 0.5% w/w monoglycerides. In some embodiments, the ethyl ester concentrate, finished product or intermediate is characterized in being substantially free of monoglycerides. In some embodiments, the ethyl ester concentrate, finished product or intermediate comprises less than about 0.5% w/w of a combination of diglycerides and triglycerides. In some embodiments, the ethyl ester concentrate, finished product or intermediate comprises less than about 0.1% w/w of a combination of diglycerides and triglycerides. In some embodiments, the ethyl ester concentrate, finished product or intermediate comprises greater than about 40% DHA. In some embodiments, the ethyl ester concentrate, finished product or intermediate comprises from about 40% to about 60% DHA. In some embodiments, the ethyl ester concentrate, finished product or intermediate the ethyl ester concentrate remains substantially clear when stored at 0° C. for 3 hours in the absence of a cold filtration process. In some embodiments, the ethyl ester concentrate, finished product or intermediate the ethyl ester concentrate contains substantially no solid precipitates when stored at 4° C. for more than 1, 5, 10, 20, 50 or 100 days. In some embodiments, the ethyl ester concentrate, finished product or intermediate contains no solid precipitates when stored at 4° C. for more than 1, 5, 10, 20, 50 or 100 days.

In some embodiments, the present invention provides a fatty acid concentrate, finished product or intermediate, of DHA, comprising greater than 35% DHA in free fatty acid form and less than 3% monoglycerides. In some embodiments, the fatty acid concentrate, finished product or intermediate comprises less than about 2% w/w monoglycerides. In some embodiments, the fatty acid concentrate, finished product or intermediate comprises less than about 1% w/w monoglycerides. In some embodiments, the fatty acid concentrate, finished product or intermediate comprises less than about 0.5% w/w monoglycerides. In some embodiments, the fatty acid concentrate, finished product or intermediate is characterized in being substantially free of monoglycerides. In some embodiments, the fatty acid concentrate, finished product or intermediate comprises less than about 0.5% w/w of a combination of diglycerides and triglycerides. In some embodiments, the fatty acid concentrate, finished product or intermediate comprises less than about 0.1% w/w of a combination of diglycerides and triglycerides. In some embodiments, the fatty acid concentrate, finished product or intermediate comprises greater than about 40% DHA. In some embodiments, the fatty acid concentrate, finished product or intermediate comprises from about 40% to about 60% DHA. In some embodiments, the fatty acid concentrate, finished product or intermediate comprises remains substantially clear when stored at 0° C. for 3 hours in the absence of a cold filtration process. In some embodiments, the fatty acid concentrate, finished product or intermediate contains substantially no solid precipitates when stored at 4° C. for more than 1, 5, 10, 20, 50 or 100 days. In some embodiments, the fatty acid concentrate, finished product or intermediate comprises contains no solid precipitates when stored at 4° C. for more than 1, 5, 10, 20, 50 or 100 days.

In some embodiments, the present invention provides a food products and functional foods, dietary supplements, nutritional supplements, and pharmaceutical products contains the ethyl ester or fatty acid concentrates described in detail above. In some preferred embodiments, the present invention provides oral delivery vehicles, such as gel-caps, syrups, and chewable solids or gels comprising ethyl ester or fatty acid concentrates described in detail above.

### DESCRIPTION OF THE INVENTION

The Omega-3-Acid Ethyl Esters 60 Monograph 2063 of the European Pharmacopeia indicates that the combined content monoglycerides and oligomers should not exceed 7.0% in omega-3 fatty acid preparations. Typically, monoglycerides contain less EPA and DHA than the ethyl esters and represents a loss. Further, the monoglycerides have a higher melting point and the product therefore typically will need a cold filtration step to pass a cold test conventionally used in the marine oil industry. To pass this test, no solid precipitation shall occur in a test tube within 3 hours if the test tube is immersed in water with ice for 3 hours. If monoglycerides are removed, a cold filtration step would not be necessary for high concentrates of EPA and DHA.

In WO 2007/052162 A2, an example is given on concentration of DHA in the form of fatty acid ethyl esters. The ester mixture is allowed to react with glycerol using an immobilized catalyst for synthesis. DHA very slowly esterified with glycerol compared to the other fatty acid ethyl esters and was accumulated as un-reacted ethyl esters, whereas the majority of all other fatty acid ethyl esters was esterified. A concentrate of DHA was obtained by distilling the mixture. The concentrated distillate of DHA however, contained 14% of monoglycerides. This product would be ideal for a further processing as described in the present invention. An immobilized lipase could be added to the product and the monoglycerides in the mixture would be converted into triglycerides and diglycerides that after an additional distillation step would be isolated in the residue whereas a DHA concentrate free of monoglycerides is collected as a distillate.

In U.S. Pat. No. 6,518,049 B1, Haraldsson et. al. showed how a concentrate of DHA can be made by esterification of a mixture of free fatty acids from a marine oil to glycerol. To the free fatty acid mixture, glycerol and immobilized Rhizomucor miehei lipase was added (Example 1, col 6. line 15). DHA very slowly reacted with glycerol and accumulated in the free fatty acid fraction whereas the other fatty acids were substantially converted to glycerides. This mixture (example 13, col. 14, line 54) was subjected to molecular distillation. The distillate fraction contained 15% monoglycerides.

In some embodiments, the present invention provides methods for removing monoglycerides or reducing the monoglyceride content of compositions such as those produced by the methods described above, such as the Haraldsson method. Immobilized enzyme is added to such a composition containing an undesirable amount of monoglycerides to esterify free fatty acids with the monoglycerides present in the composition, resulting in di- and triglycerides that will not co-distill with free fatty acids of DHA. Therefore, in preferred embodiments, a DHA product free of monglycerides is produced.

Accordingly, in some embodiments, the present invention provides processes for obtaining a fatty acid ethyl ester concentrate of polyunsaturated fatty acids comprising less than approximately 5%, 4%, 3%, 2%, 1% or 0.5% of monoglycerides on a weight/weight (w/w) basis. In some embodiments, the processes comprise a) adding a catalyst to a preparation of fatty acid ethyl esters, and in particularly preferred embodiments fatty acid ethyl esters prepared from a fish oil or other marine oil, and allowing ethyl esters to react with monoglycerides to obtain di- and triglycerides and b) collecting an ethyl ester composition substantially free of monoglycerides by a subsequent distillation step. In some embodiments, the catalyst is a lipase. In some embodiments, the lipase is immobilized. In some embodiments, the lipase is Thermomyces Lanuginosus lipase, Rhizomucor miehei lipase, Candida Arctica lipase, Pseudomonas fluorescense lipase or Mucor javanicus lipase.

In some embodiments, the present invention provides an ethyl ester concentrate of DHA produced by the process described above comprising less than about 5%, 4%, 3%, 2%, 1% or 0.5% monoglycerides w/w. In other embodiments, the ethyl ester concentrate comprises from about 0.1% to about 5%, from about 0.1% to 4%, from about 0.1% to 3%, from about 0.1% to about 2%, or from about 0.1% to 1% monoglycerides w/w. In other embodiments, the ethyl ester concentrate comprises from about 0.2% to about 5%, from about 0.2% to 4%, from about 0.2% to 3%, from about 0.2% to about 2%, or from about 0.2% to 1% monoglycerides w/w. In other embodiments, the ethyl ester concentrate comprises from about 0.5% to about 5%, from about 0.5% to 4%, from about 0.5% to 3%, from about 0.5% to about 2%, or from about 0.5% to 1% monoglycerides w/w. In some embodiments, the compositions comprise greater than 20%, 30%, 40%, 50%, or 60% ethyl esters of DHA w/w. In some embodiments, the compositions comprise from about 30% to 60% ethyl esters of DHA, preferably from about 35% to about 60% ethyl esters of DHA, and more preferably from about 40% to about 60% ethyl esters of DHA. In some embodiments, the composition comprise less than about 5%, 4%, 3%, 2%, 1%, 0.5% or 0.1% diacylglycerols, triacylglycerols, or combinations thereof. In some embodiments, the ethyl ester concentrates do not require any cold filtration process to comply with the cold test widely used in the omega-3 industry. In some embodiments, the concentrates remain substantially clear, transparent and/or homogenous when stored at 0° C. for 3 hours. In some embodiments, the concentrates remain substantially clear when stored at 0° C. for 3 hours in the absence of a cold filtration process. In some embodiments, the compositions comprise greater than 20%, 30%, 40%, 50%, or 60% ethyl esters of DHA w/w and substantially no solid precipitates when stored at 4° C. for more than 1, 5, 10, 20, 50 or 100 days. In some embodiments, the compositions comprise greater than 20%, 30%, 40%, 50%, or 60% ethyl esters of DHA w/w and no solid precipitates when stored at 4° C. for more than 1, 5, 10, 20, 50 or 100 days. In some embodiments, the compositions comprise greater than 20%, 30%, 40%, 50%, or 60% ethyl esters of DHA w/w and remain substantially clear, transparent and/or homogenous when stored at 4° C. for more than 1, 5, 10, 20, 50 or 100 days.

In other embodiments, the present invention provides processes for obtaining a fatty acid concentrate of polyunsaturated fatty acids comprising less than approximately 5%, 4%, 3%, 2%, 1% or 0.5% of monoglycerides on a weight/weight (w/w) basis. In some embodiments, the processes comprise process to remove glycerides from a DHA concentrate product or intermediate comprising free fatty acids and glycerides, said process comprising a) adding a catalyst to a DHA concentrate to form a reaction mixture and applying a vacuum to esterify said free fatty acids to said glycerides; and b) distilling said reaction mixture. In some embodiments, the catalyst is a lipase. In some embodiments, the lipase is immobilized. In some embodiments, the lipase is Thermomyces Lanuginosus lipase, Rhizomucor miehei lipase, Candida Arctica lipase, Pseudomonas fluorescense lipase or Mucor javanicus lipase.

In some embodiments, the present invention provides a fatty acid concentrate of DHA produced by the process described above comprising less than about 5%, 4%, 3%, 2%, 1% or 0.5% monoglycerides w/w. In other embodiments, the fatty acid concentrate comprises from about 0.1% to about 5%, from about 0.1% to 4%, from about 0.1% to 3%, from about 0.1% to about 2%, or from about 0.1% to 1% monoglycerides w/w. In other embodiments, the fatty acid concentrate comprises from about 0.2% to about 5%, from about 0.2% to 4%, from about 0.2% to 3%, from about 0.2% to about 2%, or from about 0.2% to 1% monoglycerides w/w. In other embodiments, the fatty acid concentrate comprises from about 0.5% to about 5%, from about 0.5% to 4%, from about 0.5% to 3%, from about 0.5% to about 2%, or from about 0.5% to 1% monoglycerides w/w. In some embodiments, the compositions comprise greater than 20%, 30%, 40%, 50%, or 60% ethyl esters of DHA w/w. In some embodiments, the compositions comprise from about 30% to 60% ethyl esters of DHA, preferably from about 35% to about 60% ethyl esters of DHA, and more preferably from about 40% to about 60% ethyl esters of DHA. In some embodiments, the compositions comprise less than about 5%, 4%, 3%, 2%, 1%, 0.5% or 0.1% diacylglycerols, triacylglycerols, or combinations thereof. In some embodiments, the fatty acid concentrates do not require any cold filtration process to comply with the cold test widely used in the omega-3 industry. In some embodiments, the concentrates remain substantially clear when stored at 0° C. for 3 hours. In some embodiments, the concentrates remain substantially clear, transparent and/or homogenous when stored at 0° C. for 3 hours in the absence of a cold filtration process. In some embodiments, the compositions comprise greater than 20%, 30%, 40%, 50%, or 60% DHA fatty acids w/w and substantially no solid precipitates when stored at 4° C. for more than 1, 5, 10, 20, 50 or 100 days. In some embodiments, the compositions comprise greater than 20%, 30%, 40%, 50%, or 60% DHA fatty acids w/w and no solid precipitates when stored at 4° C. for more than 1, 5, 10, 20, 50 or 100 days. In some embodiments, the compositions comprise greater than 20%, 30%, 40%, 50%, or 60% ethyl esters of DHA w/w and remain substantially clear, transparent and/or homogenous when stored at 4° C. for more than 1, 5, 10, 20, 50 or 100 days.

In some preferred embodiments, the ethyl ester or fatty acid compositions used in the processes described are marine oils or prepared from marine oils. Suitable marine oils include, but are not limited to, fish oils such as menhaden oil, anchovy oil, herring oil, salmon oil, cold water fish oils, and blends thereof, squid oil, krill oil, mammalian marine oils such as seal oil, and the like. In some preferred embodiments, the starting material for the process is an ethyl ester concentrate prepared from a marine oil. The preparation of such ethyl ester concentrates from marine oils is well known in the art.

The ethyl ester and fatty acid concentrates produced by the methods described above have a variety of uses.

In some embodiments, the present invention provides dietary supplements comprising the fatty acid or ethyl ester concentrates. The ingredients of the dietary supplement of this invention are contained in acceptable excipients and/or carriers for oral consumption and preferably include an antioxidant including, but not limited to Controx, Covi-OX, lecithin, and oil soluble forms of vitamin C (ascorbyl palmitate). The actual form of the carrier, and thus, the dietary supplement itself, is not critical. The carrier may be a liquid, gel, gelcap, capsule, powder, solid tablet (coated or non-coated), tea, or the like. The dietary supplement is preferably in the form of a tablet or capsule and most preferably in the form of a soft gelatin capsule. In other embodiments, the supplement is provided as a powder or liquid suitable for adding by the consumer to a food or beverage. For example, in some embodiments, the dietary supplement can be administered to an individual in the form of a powder, for instance to be used by mixing into a beverage, or by stirring into a semi-solid food such as a pudding, topping, sauce, puree, cooked cereal, or salad dressing, for instance, or by otherwise adding to a food.

The dietary supplement may comprise one or more inert ingredients, especially if it is desirable to limit the number of calories added to the diet by the dietary supplement. For example, the dietary supplement of the present invention may also contain optional ingredients including, for example, herbs, vitamins, minerals, enhancers, colorants, sweeteners, flavorants, inert ingredients, and the like. For example, the dietary supplement of the present invention may contain one or more of the following: asorbates (ascorbic acid, mineral ascorbate salts, rose hips, acerola, and the like), dehydroepiandosterone (DHEA), Fo-Ti or Ho Shu Wu (herb common to traditional Asian treatments), Cat's Claw (ancient herbal ingredient), green tea (polyphenols), inositol, kelp, dulse, bioflavinoids, maltodextrin, nettles, niacin, niacinamide, rosemary, selenium, silica (silicon dioxide, silica gel, horsetail, shavegrass, and the like), spirulina, zinc, and the like. Such optional ingredients may be either naturally occurring or concentrated forms. In some embodiments, the dietary supplements further comprise vitamins and minerals including, but not limited to, calcium phosphate or acetate, tribasic; potassium phosphate, dibasic; magnesium sulfate or oxide; salt (sodium chloride); potassium chloride or acetate; ascorbic acid; ferric orthophosphate; niacinamide; zinc sulfate or oxide; calcium pantothenate; copper gluconate; riboflavin; beta-carotene; pyridoxine hydrochloride; thiamin mononitrate; folic acid; biotin; chromium chloride or picolonate; potassium iodide; sodium selenate; sodium molybdate; phylloquinone; vitamin D.sub.3; cyanocobalamin; sodium selenite; copper sulfate; vitamin A; vitamin C; inositol; potassium iodide. Suitable dosages for vitamins and minerals may be obtained, for example, by consulting the U.S. RDA guidelines.

Dietary supplements may contain between 0.1 g and 10.0 g of the fatty acid or ethyl ester concentrates, preferably between 0.5 g and 2.0 g of the fatty acid or ethyl ester concentrates, and even more preferably, approximately 1.0 g of the fatty acid or ethyl ester concentrates. The dietary supplements of the present invention may be taken one or more times daily. Preferably, the dietary supplement is administered orally one to two times daily. Frequency of administration will, of course, depend on the dose per unit (capsule or tablet) and the desired level of ingestion. Dose levels/unit can be adjusted to provide the recommended levels of ingredients per day (e.g., approximately 1 g of the fatty acids or derivatives thereof) in a reasonable number of units (e.g., two capsules or tablets taken twice a day). In preferred embodiments, the doses add up each day to the daily intake of each ingredient. In preferred embodiments, the dietary supplements are taken with meals or before meals. In other embodiments, the dietary supplements are not taken with meals.

In other embodiments, the present invention provides nutritional supplements (e.g., energy bars or meal replacement bars or beverages) comprising of the fatty acid or ethyl ester concentrates. The nutritional supplement may serve as meal or snack replacement and generally provide nutrient calories. Preferably, the nutritional supplements provide carbohydrates, proteins, and fats in balanced amounts. The nutritional supplement can further comprise carbohydrate, simple, medium chain length, or polysaccharides, or a combination thereof. A simple sugar can be chosen for desirable organoleptic properties. Uncooked cornstarch is one example of a complex carbohydrate. If it is desired that it should maintain its high molecular weight structure, it should be included only in food formulations or portions thereof which are not cooked or heat processed since the heat will break down the complex carbohydrate into simple carbohydrates, wherein simple carbohydrates are mono- or disaccharides. The nutritional supplement contains, in one embodiment, combinations of sources of carbohydrate of three levels of chain length (simple, medium and complex; e.g., sucrose, maltodextrins, and uncooked cornstarch).

Sources of protein to be incorporated into the nutritional supplement of the invention can be any suitable protein utilized in nutritional formulations and can include whey protein, whey protein concentrate, whey powder, egg, soy flour, soy milk soy protein, soy protein isolate, caseinate (e.g., sodium caseinate, sodium calcium caseinate, calcium caseinate, potassium caseinate), animal and vegetable protein and mixtures thereof. When choosing a protein source, the biological value of the protein should be considered first, with the highest biological values being found in caseinate, whey, lactalbumin, egg albumin and whole egg proteins. In a preferred embodiment, the protein is a combination of whey protein concentrate and calcium caseinate. These proteins have high biological value; that is, they have a high proportion of the essential amino acids. See Modern Nutrition in Health and Disease, eighth edition, Lea & Febiger, publishers, 1986, especially Volume 1, pages 30-32.

The nutritional supplement can also contain other ingredients, such as one or a combination of other vitamins, minerals, antioxidants, fiber and other dietary supplements (e.g., protein, amino acids, choline, lecithin, other fatty acids). Selection of one or several of these ingredients is a matter of formulation, design, consumer preference and end-user. The amounts of these ingredients added to the dietary supplements of this invention are readily known to the skilled artisan. Guidance to such amounts can be provided by the U.S. RDA doses for children and adults. Further vitamins and minerals that can be added include, but are not limited to, calcium phosphate or acetate, tribasic; potassium phosphate, dibasic; magnesium sulfate or oxide; salt (sodium chloride); potassium chloride or acetate; ascorbic acid; ferric orthophosphate; niacinamide; zinc sulfate or oxide; calcium pantothenate; copper gluconate; riboflavin; beta-carotene; pyridoxine hydrochloride; thiamin mononitrate; folic acid; biotin; chromium chloride or picolonate; potassium iodide; sodium selenate; sodium molybdate; phylloquinone; vitamin D₃; cyanocobalamin; sodium selenite; copper sulfate; vitamin A; vitamin C; inositol; potassium iodide.

Flavors, coloring agents, spices, nuts and the like can be incorporated into the product. Flavorings can be in the form of flavored extracts, volatile oils, chocolate flavorings, peanut butter flavoring, cookie crumbs, crisp rice, vanilla or any commercially available flavoring. Examples of useful flavoring include, but are not limited to, pure anise extract, imitation banana extract, imitation cherry extract, chocolate extract, pure lemon extract, pure orange extract, pure peppermint extract, imitation pineapple extract, imitation rum extract, imitation strawberry extract, or pure vanilla extract; or volatile oils, such as balm oil, bay oil, bergamot oil, cedarwood oil, walnut oil, cherry oil, cinnamon oil, clove oil, or peppermint oil; peanut butter, chocolate flavoring, vanilla cookie crumb, butterscotch or toffee. In one embodiment, the dietary supplement contains cocoa or chocolate.

Emulsifiers may be added for stability of the final product. Examples of suitable emulsifiers include, but are not limited to, lecithin (e.g., from egg or soy), and/or mono- and di-glycerides. Other emulsifiers are readily apparent to the skilled artisan and selection of suitable emulsifier(s) will depend, in part, upon the formulation and final product. Preservatives may also be added to the nutritional supplement to extend product shelf life. Preferably, preservatives such as potassium sorbate, sodium sorbate, potassium benzoate, sodium benzoate or calcium disodium EDTA are used.

In addition to the carbohydrates described above, the nutritional supplement can contain natural or artificial (preferably low calorie) sweeteners, e.g., saccharides, cyclamates, aspartamine, aspartame, acesulfame K, and/or sorbitol. Such artificial sweeteners can be desirable if the nutritional supplement is intended to be consumed by an overweight or obese individual, or an individual with type II diabetes who is prone to hyperglycemia. The nutritional supplement can be provided in a variety of forms, and by a variety of production methods. In a preferred embodiment, to manufacture a food bar, the liquid ingredients are cooked; the dry ingredients are added with the liquid ingredients in a mixer and mixed until the dough phase is reached; the dough is put into an extruder, and extruded; the extruded dough is cut into appropriate lengths; and the product is cooled. The bars may contain other nutrients and fillers to enhance taste, in addition to the ingredients specifically listed herein.

In still further embodiments, the present invention provides food products, prepared food products, or foodstuffs comprising the fatty acid or ethyl ester concentrates. For example, in some embodiments, beverages and solid or semi-solid foods comprising the fatty acids or derivatives thereof are provided. These forms can include, but are not limited to, beverages (e.g., soft drinks, milk and other dairy drinks, and diet drinks), baked goods, puddings, dairy products, confections, snack foods, or frozen confections or novelties (e.g., ice cream, milk shakes), prepared frozen meals, candy, snack products (e.g., chips), soups, spreads, sauces, salad dressings, prepared meat products, cheese, yogurt and any other fat or oil containing foods, and food ingredients (e.g., wheat flour).

### Example 1

300 grams of a fatty acid ethyl ester concentrate with approximately 500 mg docosahexanenoic acid (DHA) pr. 1000 mg, containing 6% mono-acyl glycerols (MAG), was filled into a vacuum flask. 3.0 grams of immobilized enzyme preparation TL IM was added to the mixture and vacuum was applied to less than 1 mbar while stirring with magnetic bar for 24 hours at 60 C. Then the oil was degassed in a molecular distillation plant before it was distilled at 150 C and 0.001 mbar. From the distillation, 86.72% distillate was collected as well as 13.28% residue.

The oil was analysed by Gel Permeation Chromatography before treatment, after enzymatic treatment and after distillation. (Tab.1.) The values obtained by analysis corresponded to the observed yield in the distillation.

TABLE l

| | FAEE | MAG | DAG | TAG |
|---|---|---|---|---|
| Starting material | 93.0 | 6.0 | 0 | 0 |
| Enzyme treated | 93 | <1.0 | 4.0 | 9.3 |
| Distillate | 99 | 0.5 | 0 | 0 |
| Residue | 9.4 | 4.25 | 21.3 | 65.1 |

### Example 2

A sample of an of ethyl ester of a concentrate of EPA and DHA was shown by gas chromatography, injecting the ester directly after dilution in a solvent, to contain 13% EPA and 44% DHA. The sample was shown by size exclusion chromatography to contain minor amounts of monoglycerides, but without traces of diglycerides and triglycerides.

To 123 gram of said sample, 1.32 gram of Novozyme TL IM was added along with a magnet stirring bar to a vacuum flask placed in water bath at 40 C. A vacuum of 1 mbar was applied while stirring for 24 hours. No glycerol was added. As can be seen in the tabulated data, 4% of triglycerides and 2.4% of diglycerides was formed. The monoglyceride peak decreased from 11.5 to 8.9%. However, examination of the monoglyceride shoulder (on the FAEE peak) by gas chromatography, did show substantial impurity by monounsaturated ethyl ester. Triglycerides and Diglycerides amounted to 6.4% totally. This corresponds well to an initial amount of about 2.6% of monoglycerides (11.5−8.9) having been removed from the sample.

| Sampled | FAEE | MG shoulder | DG | TG |
|---|---|---|---|---|
| before | 88.5 | 11.5 | 0 | 0 |
| after 18 hours | 85.0 | 9.1 | 2.4 | 3.6 |
| after 24 hours | 84.6 | 8.9 | 2.4 | 4.0 |

### Example 3

952 grams of a crude ethyl ester was distilled at 90 C and 0.001 mbar on a laboratory molecular distillation plant to yield 146 grams of distillate (DI) and 806 grams of residue. The residue was redistilled at 160 C and 0.001 mbar to yield 672 grams of distillate (RD) and 134 grams of residue (RR). The RD fraction, high in EPA and DHA also contained substantial amounts of monoglycerides. To 500 gram of the RD, 5.3 grams of TL IM was added and full vacuum (<1 mbar), was applied while stirring for 65 hours at 40 C. Then 434 grams of the sample was redistilled at 160 C and 0.001 mbar to remove the formed di- and triglycerides. This distillation yielded 50 gram (11.5%) of residue (diglycerides and triglycerides) and 384 gram (88.5%) of ethyl ester free of monoglycerides. Further TL IM when transesterifying ethyl esters to di- and triglycerides showed some selectivity for the present monounsaturated fatty acid ethyl esters, enhancing the content of EPA and DHA slightly in the monoglyceride free ethyl ester as can be shown in the table below.

| | EPA area % by GC | DHA area % by GC |
|---|---|---|
| Ethyl ester before TL IM | 15.37 | 34.64 |
| treatment | | |
| Ethyl ester distillate after TL | 15.51 | 35.07 |
| IM treatment | | |
| Ethyl ester residue after TL IM | 12.65 | 22.93 |
| treatment | | |

### REFERENCES

European Pharmacopeia
WO2007/052162 A2 Concentration of fatty acid alkyl esters by enzymatic reactions with glycerol.
U.S. Pat. No. 6,518,049 B1

All publications and patents mentioned in the above specification are herein incorporated by reference. Various modifications and variations of the described method and system of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are obvious to those skilled in the relevant fields are intended to be within the scope of the following claims.

What is claimed is:

1. A process to remove monoglycerides from a fatty acid ethyl ester concentrate of polyunsaturated fatty acids comprising
a) treating an ethyl ester composition comprising fatty acid ethyl esters and an undesirable amount of monoglycerides under conditions with a catalyst such that said fatty acid ethyl esters react with said monoglycerides to produce di- and triglycerides; and
b) distilling said composition to collect an ethyl ester concentrate comprising less than about 3% w/w monoglycerides.

2. The process of claim 1, wherein said undesirable amount of monoglycerides is more than 5% monoglycerides w/w or the composition.

3. The process of claim 1, further comprising the step of applying a vacuum during said treating so that free fatty acids are esterified to said glycerides.

4. The process of claim 1, wherein said ethyl ester composition is prepared from a marine oil.

5. The process of claim 4, wherein said marine oil is a fish oil or squid oil.

6. The process of claim 1, wherein said catalyst is a lipase.

7. The process of claim 6, wherein said lipase is immobilized.

8. The process of claim 7, wherein said lipase is selected from the group consisting of Thermomyces Lanuginosus lipase, Rhizomucor miehei lipase, Candida Arctica lipase, Pseudomonas fluorescense lipase and Mucor javanicus lipase.

9. The process of claim 1, further comprising distilling said composition to collect an ethyl ester concentrate comprising less than about 2% w/w monoglycerides.

10. The process of claim 1, further comprising distilling said composition to collect an ethyl ester concentrate comprising less than about 1% w/w monoglycerides.

11. The process of claim 1, further comprising distilling said composition to collect an ethyl ester concentrate comprising less than about 0.5% w/w monoglycerides.

12. The process of claim 1, further comprising distilling said composition to collect an ethyl ester concentrate that is substantially free of monoglycerides.

13. The process of claim 1, wherein said ethyl ester concentrate produced by said distilling comprises less than about 0.5% w/w of a combination of diglycerides and triglycerides.

14. The process of claim 1, wherein said ethyl ester concentrate produced by said distilling comprises less than about 0.1% w/w of a combination of diglycerides and triglycerides.

15. The process of claim 1, wherein said ethyl ester concentrate produced by said distilling comprises greater than about 35% DHA.

16. The process of claim 1, wherein said ethyl ester concentrate produced by said distilling comprises greater than about 40% DHA.

17. The process of claim 1, wherein said ethyl ester concentrate produced by said distilling comprises from about 40% to about 60% DHA.

18. The process of claim 1, wherein said ethyl ester concentrate remains substantially clear when stored at 0° C. for 3 hours in the absence of a cold filtration process.

19. The process of claim 1, wherein said ethyl ester concentrate contains substantially no solid precipitates when stored at 4° C. for more than 1, 5, 10, 20, 50 or 100 days.

20. The process of claim 19, wherein said ethyl ester concentrate contains no solid precipitates when stored at 4° C. for more than 1, 5, 10, 20, 50 or 100 days.

21. An ethyl ester concentrate, finished product or intermediate, of DHA, comprising greater than 35% DHA in ethyl ester form and less than 3% monoglycerides.

22. The ethyl ester concentrate, finished product or intermediate, of DHA of claim 21, comprising less than about 2% w/w monoglycerides.

23. The ethyl ester concentrate, finished product or intermediate, of DHA of claim 21, comprising less than about 1% w/w monoglycerides.

24. The ethyl ester concentrate, finished product or intermediate, of DHA of claim 21, comprising less than about 0.5% w/w monoglycerides.

25. The ethyl ester concentrate, finished product or intermediate, of DHA of claim 21, characterized in being substantially free of monoglycerides.

26. The ethyl ester concentrate, finished product or intermediate, of DHA of claim 21, comprising less than about 0.5% w/w of a combination of diglycerides and triglycerides.

27. The ethyl ester concentrate, finished product or intermediate, of DHA of claim 21, comprising less than about 0.1% w/w of a combination of diglycerides and triglycerides.

28. The ethyl ester concentrate, finished product or intermediate, of DHA of claim 21, comprising greater than about 40% DHA.

29. The ethyl ester concentrate, finished product or intermediate, of DHA of claim 21, comprising from about 40% to about 60% DHA.

30. The ethyl ester concentrate, finished product or intermediate, of DHA of claim 21, wherein said ethyl ester concentrate remains substantially clear when stored at 0° C. for 3 hours in the absence of a cold filtration process.

31. The ethyl ester concentrate, finished product or intermediate, of DHA of claim 21, wherein said ethyl ester concentrate contains substantially no solid precipitates when stored at 4° C. for more than 1, 5, 10, 20, 50 or 100 days.

32. The ethyl ester concentrate, finished product or intermediate, of DHA of claim 21, wherein said ethyl ester concentrate contains no solid precipitates when stored at 4° C. for more than 1, 5, 10, 20, 50 or 100 days.

33. A functional food comprising the ethyl ester concentrate of claim 21.

34. An oral delivery vehicle comprising the ethyl ester concentrate of claim 21.
